(19) United States
(12) Patent Application Publication
(10) Pub. No.: US 2002/0104944 A1
(43) Pub. Date: Aug. 8, 2002

(54) Bracket apparatus and method for mounting a personal computing appliance to a wall

(76) Inventors: Douglas J. Pogatetz, Arlington Heights, IL (US); Kevin J. Schechtel, Algonquin, IL (US); David G. Padgitt, Schaumburg, IL (US); Brian D. Furlong, Westchester, IL (US); Timothy K. Nowack, Chicago, IL (US)

Correspondence Address: Baniak Pine & Gannon, 150 N. Wacker Drive, Suite 1200, Chicago, IL, 60606, US

(21) Appl. No.: 09/777,045

(22) Filed: Feb. 5, 2001

(51) Int. Cl. B23P 11/00; A47F 5/00

(52) U.S. Cl. 248/309.1; 29/428; 248/302

(57) ABSTRACT

A bracket apparatus and method for mounting a personal computing device to a wall is provided. The bracket apparatus includes a bracket for retaining and supporting a personal computing appliance. The bracket is adapted to be mounted to a wall. The bracket includes a wall mounting portion, a personal computing appliance mounting portion, and a plurality of mounting pads attached to the personal computing appliance mounting portion for contacting and retaining the personal computing appliance.

### FIELD OF THE INVENTION

This invention relates generally to the field of mechanical brackets and in particular, to a bracket apparatus and method for mounting a personal computing appliance to a wall.

### BACKGROUND OF THE INVENTION

Conventional handheld computing devices such as, for example, the Palm Pilot manufactured and sold by 3Com Corporation, of Santa Clara, California, typically include a touch sensitive display screen and a stylus. These handheld computing devices are commonly referred to as personal digital assistants (PDA). The stylus for these PDA's is a writing utensil that enables the operator to input data into the device via the display screen. The stylus is typically shaped like a small thin pencil or pen to allow the user to grasp and manipulate the stylus.

In response to consumer demand and technological advances, other types of specialized computing devices have been designed to provide a combination of PDA-like functions with more powerful applications, like full feature Internet conductivity and e-mail capability. These specialized computing devices are typically smaller than a conventional personal computer (PC), and yet larger than a conventional PDA. These specialized computing devices are oftentimes referred to as a personal computing appliance (PCA). These devices may also be referred to as an Internet appliance (when provided with Internet capability) or electronic computing appliance. Typically these devices are relatively small (about the size of a sub-notebook) compared to conventional personal computers, have a relatively small footprint and, while more portable than many “portable computers,” are intended to be used as a countertop computing device.

A conventional PCA (which may be referred to as a household digital assistant) typically may include an outer housing, a central processing unit “CPU,” computer readable program code, and a touch activated screen. A stylus is typically provided to allow a user to input data into the device via the display screen. In addition, a wireless keyboard may also be provided, which allows the user to input data into the PCA in a conventional manner.

As stated above, a conventional PCA may preferably be positioned on a countertop such as, for example, a kitchen countertop. The disadvantage of this arrangement is that the PCA and its associated keyboard, although relatively small, may nonetheless occupy a considerable amount of counter space, which typically is at a premium in most residential and commercial dwellings. As a result, when the device is not in use, and the occupied counter space is needed for other tasks, a user may have to move the appliance and store it in a different location. If this occurs, then the user must then retrieve the device from storage to use the device. Moreover, because the PCA, the keyboard, and the stylus are separate elements, they may be misplaced during the process of storing and retrieving the device.

Accordingly, it would be desirable to have a bracket apparatus that allows the PCA, keyboard, and stylus to be conveniently and quickly mounted to a wall without requiring any tools or fasteners. It would also be desirable to have a bracket apparatus that allows the keyboard to be positioned in either a stowed position when not in use or operating position during operation. Finally, it would be desirable to have a bracket apparatus that allows the stylus to be stowed along with the PCA.

### SUMMARY OF THE INVENTION

One aspect of the invention provides a bracket apparatus including a bracket for retaining and supporting a personal computing appliance. The bracket is adapted to be mounted to a wall, and includes a wall mounting portion, a personal computing appliance mounting portion, and a plurality of mounting pads attached to the personal computing appliance mounting portion for contacting and retaining the personal computing appliance. The plurality of mounting pads may preferably be comprised at least four mounting pads. Each of the plurality of mounting pads may preferably include a concave body portion. The plurality of mounting pads may preferably include first and second side mounting pads for contacting first and second sides of the personal computing appliance. Each of the first and second side mounting pads may preferably be attached to a first end of the personal computing appliance mounting portion. The first side mounting pad may preferably be spaced apart from the second side mounting pad and may preferably be positioned opposite the second side mounting pad. The plurality of mounting pads may preferably include third and fourth bottom mounting pads for contacting a bottom side of the personal computing appliance. Each of the third and fourth bottom mounting pads may preferably be attached to a second end of the personal computing appliance mounting portion. The third bottom mounting pad may preferably be spaced apart from the fourth mounting pad.

The wall mounting portion may preferably include at least one planar flange member for contacting the wall. The at least one flange member may preferably include first and second planar flange members. The first planar flange member may preferably be positioned along a first side of the wall mounting portion and the second planar member may preferably be positioned along a second side of the wall mounting portion. Each of the two flange planar members may preferably include at least one through opening. The at least one through opening may preferably include two openings. The personal computing appliance mounting portion may preferably be angled with respect to the wall mounting portion. The personal computing appliance mounting portion may preferably be angled approximately 20 degrees with respect to the wall mounting portion. The wall mounting portion may preferably include a generally horizontal cross member extending from a first side of the wall mounting portion to a second side of the wall mounting portion.

A keyboard holder for holding a keyboard may also be provided. The keyboard holder may preferably be rotatably attached to the bracket to allow the keyboard holder to be rotated between a stowed position and an operating position. The keyboard holder may preferably include first and second keyboard mounting pads for contacting and retaining the keyboard. The first keyboard mounting pad may preferably be positioned along a first side of the keyboard holder and the second keyboard mounting pad may preferably be positioned along a second side of the keyboard holder. The first keyboard mounting pad may preferably be positioned opposite the second keyboard mounting pad. The keyboard holder may preferably include a first rod member to allow the keyboard holder to be rotatably attached to the bracket. The first rod may preferably be attached to at least two of the plurality of mounting pads. The keyboard holder may preferably include a second rod member to allow the keyboard holder to be locked in the operating position. The second rod may preferably be attached to the at least two of the plurality of mounting pads. The keyboard holder may preferably include a support member extending from the first side of the keyboard holder to the second side of the keyboard holder to allow the keyboard to be positioned on the support member.

A stylus holder for holding a stylus may also be provided. The stylus holder may preferably be rotatably attached to the bracket to allow the stylus holder to be rotated between an unlatched position and a latched position. The stylus holder may preferably include a channel portion to receive and retain the stylus. The stylus holder may preferably include a first rod member to allow the stylus holder to be rotatably attached to the bracket. The first rod member may preferably be attached to at least two of the plurality of mounting pads. The stylus holder may also preferably include a second rod member to allow the stylus holder to be locked in the latched position. The second rod member may preferably be attached to the at least two of the plurality of mounting pads.

Another aspect of the invention provides a method of mounting a personal computing appliance to a wall. A bracket apparatus including a bracket is provided. The bracket is adapted to be mounted to a wall, and includes a wall mounting portion, a personal computing appliance mounting portion, and a plurality of mounting pads attached to the personal computing appliance mounting portion. The bracket is mounted to the wall. The personal computing appliance is positioned between the plurality of mounting pads. The plurality of mounting pads is contacted against the personal computing device thereby retaining and supporting the personal computing appliance. A keyboard holder for holding a keyboard may also be provided. The keyboard holder may preferably be rotatably attached to the bracket. The keyboard holder is rotated from a stowed position to an operating position and vice versa. A stylus holder for holding a stylus may also be provided. The stylus holder may preferably be attached to the bracket. The stylus holder may preferably be rotated from an unlatched position to a latched position, and vice versa.

Another aspect of the invention provides an apparatus for mounting a personal computing appliance and keyboard to a wall. A bracket for retaining and supporting a personal computing appliance is provided. The bracket is adapted to be mounted to a wall. The bracket includes a wall mounting portion, a personal computing appliance mounting portion, and a plurality of mounting pads attached to the personal computing appliance mounting portion for contacting and retaining the personal computing appliance. A keyboard holder for holding a keyboard is also provided. The keyboard holder is rotatably attached to the bracket to allow the keyboard holder to be rotated between a stowed position and an operating position.

The invention provides the foregoing and other features, and the advantages of the invention will become further apparent from the following detailed description of the presently preferred embodiments, read in conjunction with the accompanying drawings. The detailed description and drawings are merely illustrative of the invention and do not limit the scope of the invention, which is defined by the appended claims and equivalents thereof.

### BRIEF DESCRIPTION OF THE DRAWINGS

FIG. 1 is a perspective view of a preferred embodiment of a bracket apparatus, a keyboard holder, and a stylus holder, each of which is made in accordance with the invention;

FIG. 2 is a perspective view of the bracket apparatus of FIG. 1 showing the keyboard holder or FIG. 1 attached to the bracket apparatus wherein a personal computing appliance is mounted onto the bracket apparatus and a keyboard is mounted onto the keyboard;

FIG. 3 is a side view of the embodiment of FIG. 2 showing the keyboard holder in an operating position and a stowed position (in phantom); and

FIG. 4 is a side view of the bracket apparatus of FIG. 2 showing the stylus holder attached to the bracket apparatus wherein the stylus holder is shown in the unlatched position (in phantom).

### DETAILED DESCRIPTION OF THE PRESENTLY PREFERRED EMBODIMENTS

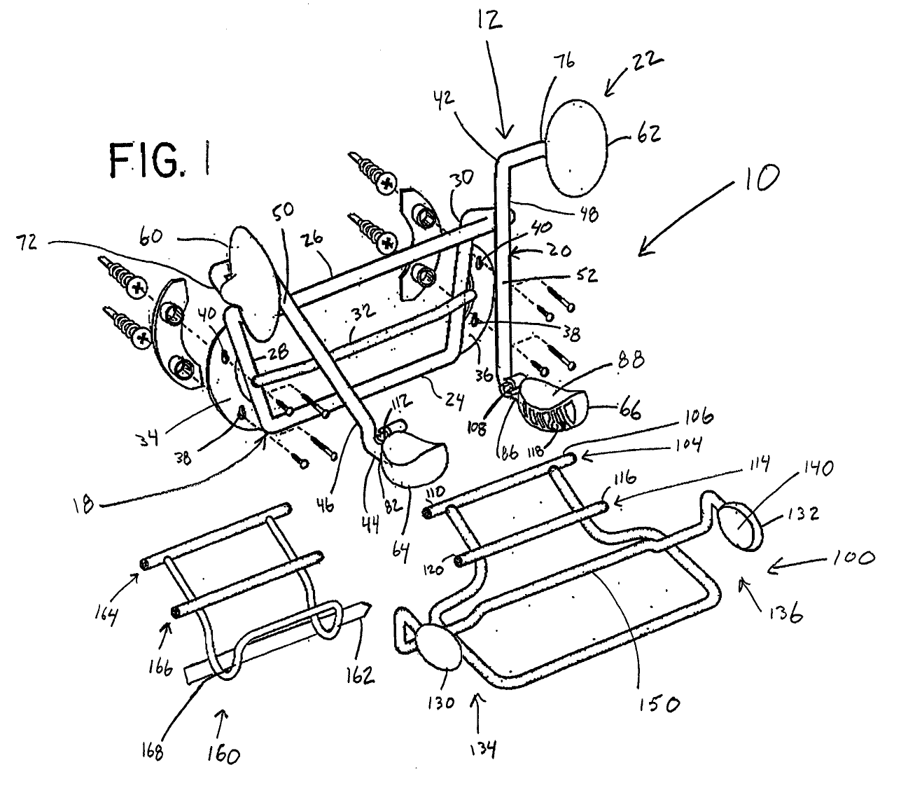

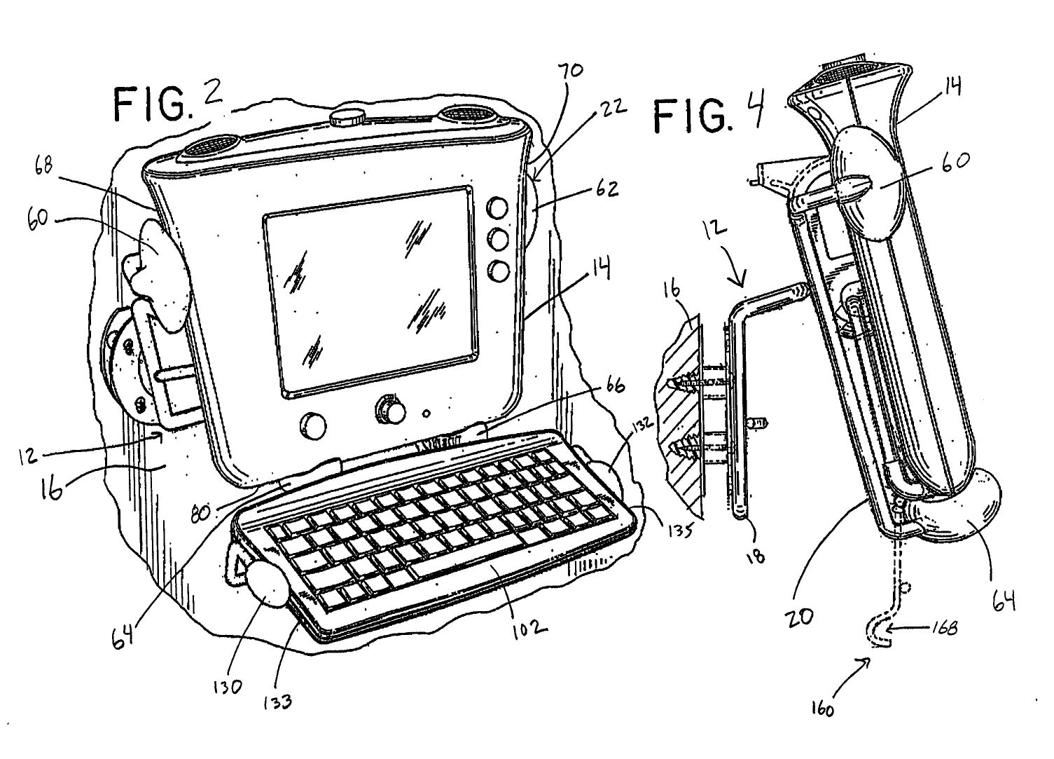

Referring to FIG. 1, a preferred embodiment of a bracket apparatus is shown generally at numeral 10. Referring to FIGS. 1 and 2, the bracket apparatus 10 includes a bracket 12 for retaining and supporting a personal computing appliance 14. As shown in FIG. 2, the bracket 12 is adapted to be mounted to a wall 16. The personal computing appliance 14 (which may be referred to as a household digital assistant) may be any of the commercially available electronic devices having a central processing unit “CPU,” computer readable program code, and a touch activated display screen.

Referring again to FIG. 1, the bracket 12 includes a wall mounting portion 18, a personal computing appliance mounting portion 20, and a plurality of mounting pads 22 attached to the personal computing appliance mounting portion 20. The wall mounting portion 18 provides a platform to allow the bracket 12 to be fastened to the wall 16. As shown in FIG. 1, the wall mounting portion 18 may preferably include a bottom portion 24, a top portion 26, a first side portion 28, and a second side portion 30. The wall mounting portion 18 may also include a generally horizontal cross member 32 extending from the first side portion 28 of the wall mounting portion 18 to the second side portion 30 of the wall mounting portion 18. In the embodiment shown, the wall mounting portion 18 has a generally rectangular shape, although other shapes and configurations are contemplated.

Referring again to FIG. 1, the wall mounting portion 18 may also include at least one planar flange member 34. In the embodiment shown, a second flange member 36 is also provided. The flange members 34, 36 allow the bracket 12 to be mounted to the wall 16. The flange member 34 is positioned along the first side portion 28 of the wall mounting portion 18 and the second planar member 36 is positioned along the second side portion 30 of the wall mounting portion 18. Each of the flange members 34, 36 may preferably have an arcuate shape, although other shapes and configurations are contemplated. Each of the two flange planar members 34, 36 may preferably include at least one through opening 38 to receive a fastener (not shown). In the embodiment shown, each of the two planar flange members 34, 36 may preferably include a second through opening 40.

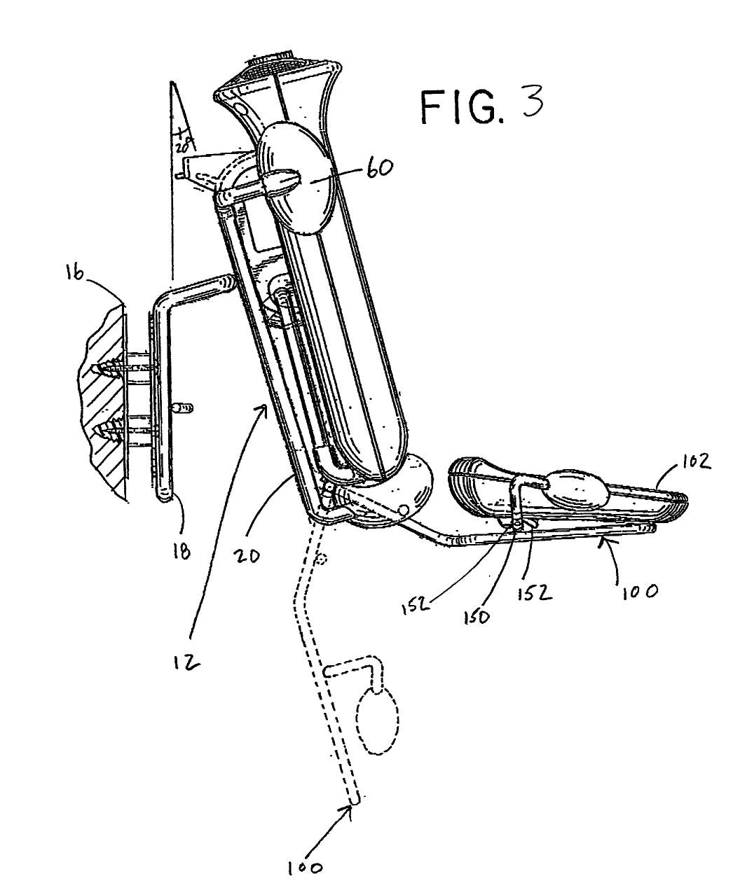

Referring again to FIG. 1, the personal computing appliance mounting portion 20 provides platform to allow the personal computing appliance 14 to be mounted to the bracket 12. In the embodiment shown, the personal computing appliance mounting portion 20 includes a first top end 42, a second bottom end 44, and first and second sides 46, 48. In the embodiment shown, for example, the personal computing appliance mounting portion 20 is comprised of a pair of rod members 50, 52, each of which are attached to the top portion 26 of the wall mounting portion 18. As shown in FIGS. 3 and 4 the personal computing appliance mounting portion 20 is angled with respect to the wall mounting portion 18. In particular, the personal computing appliance mounting portion 20 is angled approximately 20 degrees with respect to the wall mounting portion 18 (see FIG. 3).

Referring again to FIG. 1, the plurality of mounting pads 22 are attached to the bracket 12, and in particular, to the personal computing appliance mounting portion 20. As shown in FIG. 2, each of the plurality of mounting pads 22 contacts and retains the personal computing appliance 14. Each of the plurality of mounting pads 22 may preferably be comprised of a flexible insulative material such as, for example, a thermoplastic rubber. The material should be rigid enough to hold the personal computing appliance 14 firmly in place when installed. At the same time, the material should be flexible enough to allow the personal computing device 14 to be installed and removed without the use of any tools. In the embodiment shown in FIG. 1, the plurality of mounting pads 22 comprises at least four mounting pads, two side mounting pads 60, 62 and two bottom mounting pads 64, 66. As shown in FIG. 2, the first and second side mounting pads 60, 62 contact respective first and second sides 68, 70 of the personal computing appliance 14. As shown in FIG. 1, each of the first and second side mounting pads 60, 62 is attached to the first top end 42 of the personal computing appliance mounting portion 20. In particular, the first side mounting pad 60 is attached to a top end 72 of rod member 50, and the second side mounting pad 62 is attached to a top end 76 of rod member 52. The first side mounting pad 60 is spaced apart from the second side mounting pad 62, and the first side mounting pad 60 is positioned opposite the second side mounting pad 62.

Referring again to FIG. 2, the third and fourth bottom mounting pads 64, 66 contacts a bottom side 80 of the personal computing appliance 14. Referring to FIG. 1, each of the third and fourth bottom mounting pads 64, 66 is attached to the second bottom end 44 of the personal computing appliance mounting portion 20. In particular, in the embodiment shown, the third bottom mounting pad 64 is attached to a bottom end 82 of rod member 50, and the fourth bottom mounting pad 66 is attached to a bottom end 86 of rod member 52. The third bottom mounting pad 64 is spaced apart from the fourth mounting pad 66. Each of the plurality of mounting pads 22 may preferably include a concave body portion 88 to receive the personal computing appliance 14. One advantage of the bracket 12 is that it allows the personal computing appliance 14 to be mounted to a vertical wall 16. As a result, the personal computing appliance 14 does not occupy any valuable horizontal work surface such as, for example, a kitchen counter top. Moreover, the plurality mounting pads 22 allow the personal computing appliance 14 to be installed and removed without the use of any tools.

Referring again to FIGS. 1 and 2, a keyboard holder 100 for holding a keyboard 102 may also be provided. The keyboard holder 100 is rotatably attached to the bracket 12 to allow the keyboard 100 holder to be rotated between a stowed position and an operating position as shown in FIG. 3. The advantage of this arrangement is that the keyboard holder 100 can be rotated to the stowed position when the keyboard 102 is not in use. The keyboard holder 100 can also be rotated to the operating position when the keyboard is in use. In the embodiment shown in FIGS. 1 and 3, the keyboard holder 100 is rotatably attached to the third and fourth bottom mounting pads 64, 66. The keyboard holder 100 may preferably include a first rod member 104. Referring to FIG. 1, the rod member 104 allows the keyboard holder 100 to be rotatably attached to the bracket 12, and in particular, to the third and fourth bottom mounting pads 64, 66. In particular, one end portion 106 of the rod member 104 is press fit into an opening 108 formed in the fourth bottom mounting pad 66. Similarly, a second end portion 110 of the rod member 104 is press fit into an opening 112 formed in the third bottom mounting pad 64.

The keyboard holder 100 may also include a second rod member 114. The second rod member 114 allows the keyboard holder 100 to be locked in the operating position. In the embodiment shown, the second rod member 114 is attached to the third and fourth bottom mounting pads 64, 66. In particular, the one end portion 116 of the second rod member 114 is press fit into a second opening 118 formed in the fourth bottom mounting pad 66. Similarly, a second end portion 120 of the second rod member 114 is press fit into a second opening (not shown) formed in the third bottom mounting pad 64.

As shown in FIG. 1, the keyboard holder 100 also includes first and second keyboard mounting pads 130,132 for contacting and retaining the keyboard 102 (see FIG. 2). Each of the first and second keyboard mounting pads 130,132 may preferably be comprised of a flexible insulative material such as, for example, a thermoplastic rubber. The material should be rigid enough to hold the keyboard 102 firmly in place when installed. At the same time, the material should be flexible enough to allow the keyboard 102 to be installed and removed without the use of any tools. The first keyboard mounting pad 130 is positioned along a first side 134 of the keyboard holder 100 and the second keyboard mounting pad 132 is positioned along a second side 136 of the keyboard holder 100. The first keyboard mounting pad 130 is positioned opposite the second keyboard mounting pad 132. The first keyboard mounting pad 130 includes a concave surface (not shown) to facilitate contact of the first keyboard mounting pad 130 with a first side 133 of the keyboard 102. Similarly, the second keyboard mounting pad 132 also includes a concave surface 140 to facilitate contact of the second keyboard mounting pad 132 with a second side 135 of the keyboard 102. The advantage of this arrangement is that the keyboard can be affixed to the keyboard holder 100 without any fasteners or tools.

As shown in FIG. 1, the keyboard holder 100 includes a support member 150 extending from the first side 134 of the keyboard holder 100 to the second side 136 of the keyboard holder 100. The support member 150 allows the keyboard 102 to be positioned on the support member 150 when the keyboard 102 is not in use. As shown in FIG. 3, the keyboard 102 may preferably include a lip portion 152 engages that the support member 150.

Referring again to FIG. 1, a stylus holder 160 for holding a stylus 162 may also be provided. The stylus holder 160 may preferably be rotatably attached to the bracket 12 to allow the stylus holder 160 to be rotated between an unlatched position (as shown in FIG. 4) when the stylus holder 160 is not needed to retain the stylus 162 and a latched position, when the stylus holder 160 is retaining the stylus 162. The stylus holder 160 may preferably be attached to the bracket 14 in the same manner as the keyboard holder 100. In particular, the stylus holder 160 may preferably includes a first rod member 164 to allow the stylus holder 160 to be rotatably attached to the bracket 12, and in particular, to the third and fourth bottom mounting pads 64, 66. The stylus holder 160 may also include a second rod member 166 to allow the stylus holder 160 to be locked in the latched position. When in the latched position, the second rod member 166 may preferably be attached to the third and fourth bottom mounting pads 64, 66, just as the keyboard holder 100 is attached to the third and fourth bottom mounting pads 64, 66 when the keyboard holder 100 is in the operating position. The stylus holder 160 may preferably include a channel portion 168 to receive and retain the stylus 162. The advantage of this arrangement is that either the stylus holder 160 or the keyboard holder 100 may be attached to the bracket 12, depending upon the particular application, without any need for separate fasteners or tools.

Referring to FIGS. 2-4, the personal computing appliance 14 can be mounted to the wall 16 above a work surface (not shown) by mounting the bracket 12 to the wall 16. The personal computing appliance 14 may then be positioned between the plurality of mounting pads 22. In particular, the bottom side 80 of the personal computing appliance 14 is positioned above the first and second side mounting pads 60, 62, and is lowered in a downward direction until the bottom side 80 of the personal computing appliance 14 contacts the third and fourth bottom mounting portions 64, 66. When the personal computing appliance 14 is fully inserted, the first and second side mounting pads 60, 62 contact the respective first and second sides 68, 70 of the personal computing appliance 14. As a result, the bracket 12 retains and supports the personal computing appliance 14.

As shown in FIG. 3, the keyboard holder 100 may be rotatably attached to the bracket 12. The keyboard 102 may then be positioned between the first and second keyboard mounting pads 130, 132. The first and second keyboard mounting pads 130, 132 retain the keyboard 102 in a fixed position relative to the keyboard holder 100. The keyboard holder 100 may then be rotated from a stowed position to an operating position to allow a user to operate the keyboard 102. When the keyboard 102 is not in use, the keyboard holder 100 may be rotated from the operating position to the stowed position.

Alternatively, and referring to FIGS. 1 and 4, the stylus holder 160 may preferably be rotatably attached to the bracket 12. The stylus holder 160 may preferably be rotated from an unlatched position (FIG. 4) to a latched position.

Also, the stylus holder 160 may preferably be rotated from the latched position to the unlatched position. When the stylus holder 160 is in the latched position, the stylus 162 may be stowed within the channel portion 168 of the stylus holder 160 when the stylus 162 is not in use.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A bracket apparatus comprising:
a bracket for retaining and supporting a personal computing appliance, the bracket adapted to be mounted to a wall, the bracket including a wall mounting portion, a personal computing appliance mounting portion, and a plurality of mounting pads attached to the personal computing appliance mounting portion for contacting and retaining the personal computing appliance.

2. The bracket apparatus of claim 1 wherein the plurality of mounting pads comprises at least four mounting pads.

3. The bracket apparatus of claim 2 wherein each of the plurality of mounting pads includes a concave body portion.

4. The bracket apparatus of claim 3 wherein the plurality of mounting pads includes first and second side mounting pads for contacting first and second sides of the personal computing appliance, each of first and second side mounting pads attached to a first end of the personal computing appliance mounting portion, the first side mounting pad spaced apart from the second side mounting pad, the first side mounting pad positioned opposite the second side mounting pad.

5. The bracket apparatus of claim 4 wherein the plurality of mounting pads further includes third and fourth bottom mounting pads for contacting a bottom side of the personal computing appliance, each of the third and fourth bottom mounting pads attached to a second end of the personal computing appliance mounting portion, the third bottom mounting pad spaced apart from the fourth mounting pad.

6. The bracket apparatus of claim 1 wherein wall mounting portion includes at least one planar flange member for contacting the wall.

7. The bracket apparatus of claim 6 wherein the at least one flange member includes first and second planar flange members.

8. The bracket apparatus of claim 7 wherein the first planar flange member is positioned along a first side of the wall mounting portion and the second planar member is positioned along a second side of the wall mounting portion.

9. The bracket apparatus of claim 8 wherein each of the two flange planar members includes at least one through opening.

10. The bracket apparatus of claim 9 wherein the at least one through opening includes two openings.

11. The bracket apparatus of claim 1 wherein the personal computing appliance mounting portion is angled with respect to the wall mounting portion.

12. The bracket apparatus of claim 11 wherein the personal computing appliance mounting portion is angled approximately 20 degrees with respect to the wall mounting portion.

13. The bracket apparatus of claim 1 wherein the wall mounting portion includes a generally horizontal cross member extending from a first side of the wall mounting portion to a second side of the wall mounting portion.

14. The bracket apparatus of claim 1 further comprising a keyboard holder for holding a keyboard, the keyboard holder rotatably attached to the bracket to allow the keyboard holder to be rotated between a stowed position and an operating position.

15. The bracket apparatus of claim 14 wherein the keyboard holder includes first and second keyboard mounting pads for contacting and retaining the keyboard.

16. The bracket apparatus of claim 15 wherein the first keyboard mounting pad is positioned along a first side of the keyboard holder and the second keyboard mounting pad is positioned along a second side of the keyboard holder, the first keyboard mounting pad positioned opposite the second keyboard mounting pad.

17. The bracket apparatus of claim 16 wherein the keyboard holder includes a first rod member to allow the keyboard holder to be rotatably attached to the bracket.

18. The bracket apparatus of claim 17 wherein the first rod is attached to at least two of the plurality of mounting pads.

19. The bracket apparatus of claim 18 wherein the keyboard holder includes a second rod member to allow the keyboard holder to be locked in the operating position.

20. The bracket apparatus of claim 19 wherein the second rod is attached to the at least two of the plurality of mounting pads.

21. The bracket apparatus of claim 20 wherein the keyboard holder includes a support member extending from the first side of the keyboard holder to the second side of the keyboard holder to allow the keyboard to be positioned on the support member.

22. The bracket apparatus of claim 1 further comprising a stylus holder for holding a stylus, the stylus holder rotatably attached to the bracket to allow the stylus holder to be rotated between an unlatched position and a latched position.

23. The bracket apparatus of claim 22 wherein the stylus holder includes a channel portion to receive and retain the stylus.

24. The bracket apparatus of claim 23 wherein the stylus holder includes a first rod member to allow the stylus holder to be rotatably attached to the bracket.

25. The bracket apparatus of claim 24 wherein the first rod member is attached to at least two of the plurality of mounting pads.

26. The bracket apparatus of claim 25 wherein the stylus holder includes a second rod member to allow the stylus holder to be locked in the latched position.

27. The bracket apparatus of claim 26 wherein the second rod member is attached to the at least two of the plurality of mounting pads

28. A method of mounting a personal computing appliance to a wall comprising:
providing a bracket apparatus including a bracket, the bracket adapted to be mounted to a wall, the bracket including a wall mounting portion, a personal computing appliance mounting portion, and a plurality of mounting pads attached to the personal computing appliance mounting portion;
mounting the bracket to the wall;
positioning the personal computing appliance between the plurality of mounting pads;
contacting the plurality of mounting pads against the personal computing appliance; and
retaining and supporting the personal computing appliance.

29. The method of claim 28 further comprising:
providing a keyboard holder for holding a keyboard;
rotatably attaching the keyboard holder to the bracket; and
rotating the keyboard holder from a stowed position to an operating position.

30. The method of claim 29 further comprising:
rotating the keyboard holder from the operating position to the stowed position.

31. A method of claim 28 further comprising:
providing a stylus holder for holding a stylus;
rotatably attaching the stylus holder to the bracket; and
rotating the stylus holder from an unlatched position to a latched position.

32. The method claim 31 further comprising:
rotating the keyboard holder from the latched position the unlatched position.

33. An apparatus for mounting a personal computing appliance and keyboard to a wall comprising:
a bracket for retaining and supporting a personal computing appliance, the bracket adapted to be mounted to a wall, the bracket including a wall mounting portion, a personal computing appliance mounting portion, and a plurality of mounting pads attached to the personal computing appliance mounting portion for contacting and retaining the personal computing appliance, a keyboard holder for holding a keyboard, the keyboard holder rotatably attached to the bracket to allow the keyboard holder to be rotated between a stowed position and an operating position.
